(19) United States
(12) Patent Application Publication
(10) Pub. No.: US 2026/0031381 A1
(43) Pub. Date: Jan. 29, 2026

(54) ELECTROLYTE COMPOSITIONS WITH HIGH BUFFER CONCENTRATIONS

(71) Applicant: OTORO Energy, Inc., Boulder, CO (US)

(72) Inventors: Jessica A. MURDZEK, Boulder, CO (US); Brian H. ROBB, Boulder, CO (US); Michael MARSHAK, Boulder, CO (US)

(21) Appl. No.: 19/277,123

(22) Filed: Jul. 22, 2025

Related U.S. Application Data
(60) Provisional application No. 63/675,585, filed on Jul. 25, 2024.

(51) Int. Cl. H01M 8/18; H01M 8/08

(52) U.S. Cl. CPC H01M 8/188; H01M 8/08; H01M 2300/0002

(57) ABSTRACT

An electrolyte solution including a redox active species and a buffer is described. The concentration of both the redox active species and the buffer in the electrolyte solution is greater than 0.4 M. The pH of the electrolyte solution is in the range of from 5 to 11. In some embodiments of the electrolyte solution, the concentration of the buffer is equal to or greater than the concentration of the redox active species.

### CROSS-REFERENCE TO RELATED APPLICATION(S)

This application claims priority to U.S. Provisional Patent Application No. 63/675,585, entitled “ELECTROLYTE COMPOSITIONS WITH HIGH BUFFER CONCENTRATIONS”, filed Jul. 25, 2024, the entirety of which is hereby incorporated by reference.

### BACKGROUND

Chemical and electrochemical reduction can be used to convert one chemical species to another more valuable species. Examples of these types of reactions include hydrogen generation from water splitting, CO₂ reduction, and nitrogen reduction to ammonia.

In some cases, chemical or electrochemical reductions are done by using a separate, highly reducing species dissolved in solution to act as the reducing agent for the desired chemical species. The highly reducing species can act directly as a reducing agent or it can act as a redox mediator in an electrochemical process. A redox mediator interacts with an electrode and catalysts, including solid state heterogenous and homogenous catalysts, to facilitate the electrochemical reduction by providing the driving force for the reduction.

Often these chemical reductions are coupled, such that the chemical species being reduced will take in an electron and add a proton to its molecular structure, which removes a proton from solution. Removing a proton from solution will increase the pH of the solution. Because the reduction reactions may require a specific solution pH, a buffer may need to be added to solution to keep the pH from greatly shifting during the reduction process as protons are consumed. If the reduction is done by using a separate, highly reducing species as the reducing agent, then the amount of buffer will need to be greater than or equal to the concentration of the highly reducing species.

Once the highly reducing species has reacted as part of the chemical reduction, it is no longer highly reducing. However, when the solution including the high reducing species is part of an electrochemical flow cell (such as when the solution is an electrolyte solution), the highly reducing species can be recharged to its highly reducing state while performing the oxygen evolution reaction (OER) on the other electrode, which would reintroduce protons to the highly reducing species solution. Thus, the solution could be discharged and recharged and maintain the same highly reducing nature and same pH, which would allow for the species to be repeatedly used to create more of the valuable product.

Prior efforts to create solutions that have an electrochemical rechargeable active species and a buffer with an equal or greater concentration than the active species have resulted in active species concentrations of at most 0.4 M. This cap on the active species concentration limits the amount of valuable product that can be created during the chemical reduction reaction.

It is also important to select the right buffer and concentration for efficient operation of the chemical reduction reactions (see, e.g., Pletcher, D., et al. “Studies of indirect electrochemical reductions using chromium complexes with polyaminocarboxylate ligands as mediators”, Electrochimica Acta, vol. 37, issue 4 (pp. 575-583)). This has been an ongoing challenge to find combinations of redox active species and buffer that operate at the right pH and that are both highly soluble. These solutions of redox actives species with buffer are used as redox mediators in electrochemical processes and will interact with electrodes and catalysts such as solid state heterogeneous and homogeneous catalysts.

Accordingly, a critical need exists for improved electrolyte solutions including highly reducing agents and buffers, wherein the electrolyte solution includes a greater concentration of active species compared to prior art.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, an electrolyte composition is described, wherein the electrolyte composition includes a buffer and a redox active species. The concentration of the buffer in the electrolyte composition is 0.4 M or greater, and the concentration of the redox active species in the electrolyte solution is 0.4 M or greater. The electrolyte composition has a pH in the range of from 5 to 11. In some embodiments, the redox active species is an organometallic chelate, such as an organometallic chelate having Cr or Fe chelated to an aminopolycarboxylate such as ethylenediaminetetraacetic acid (EDTA) or 1,3-Diaminopropane-N,N,N′, N′-tetraacetic acid (PDTA).

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The technology described herein relates to an electrolyte solution including a redox active species and a buffer, wherein the concentration of both the redox active species and the buffer is greater than 0.4 M. This electrolyte solution is beneficial over previously known electrolyte solutions because it includes a higher redox active species concentration than has previously been reported, and this higher redox active species concentration allows for more of valuable product to be created during the chemical reduction reaction. The higher concentration of redox active species is possible at least in part because of the correspondingly high concentration of buffer included in the electrolyte solution, which helps to ensure the pH of the electrolyte solution is maintained within a pH range of 5-11. Maintaining this pH range helps to ensure that the reduction reaction can continue to take place. The technology described herein is further useful for redox reactions where the substrate or a product is a gas that is involved in a proton coupled reduction reaction. The high concentration of buffer can absorb large changes in H⁺ concentration and keep the pH steady while the reaction consumes or produces H⁺.

As noted previously, the electrolyte solution generally comprises a buffer and a redox active species, wherein the concentration of both the redox active species and the buffer is 0.4 M or greater. In one non-limiting example, the concentration of both the buffer and the redox active species is 0.5 M. Generally speaking, the concentration of the buffer is equal to or greater than the concentration of the redox active species. Thus, while many of the examples provided in this application describe examples where the concentration of the buffer is equal to the concentration of the redox active species (e.g., where the concentration of both the buffer and the redox active species is 0.4 M), it should be appreciated that the electrolyte solution may have a buffer with a concentration greater than the concentration of the redox active species. However, even in these embodiments, the concentration of both the buffer and the redox active species is greater than 0.4 M. In one non-limiting example, the concentration of the redox active species may be 0.4 M, while the concentration of the buffer is 0.5 M. In some embodiments, the upper limit of the concentration of the buffer and the redox active species is 3 M.

The buffer suitable for use in the electrolyte solution described herein is generally not limited, provided that the buffer is capable of buffering at a pH in the range of from 5 to 11. Exemplary, though non-limiting, examples of suitable buffers for the electrolyte solution described herein include phosphate, acetate, phthalate, borate, citrate, carbonate, ammonium, 2-amino-2-methyl-1,2-propanediol, tris(hydroxymethyl)aminomethane, EDTA, or PDTA.

The pH of the electrolyte solution described herein is in the range of from 5 to 11. The previously described buffer helps to maintain this pH range for the electrolyte solution, including during the electrochemical reactions that occur as part of utilizing the electrolyte solution in an electrochemical flow cell.

In some embodiments, the redox active species is an organometallic chelate. The specific type of organometallic chelate used for the redox active species of the electrolyte solution is generally not limited, though in some embodiments, organometallic chelates having a metal center of either Cr or Fe is preferred.

In some embodiments, the redox active species is an organometallic chelate where Cr or Fe is chelated to an aminopolycarboxylate. In some preferred embodiments, the organometallic chelate comprises Cr chelated to an aminopolycarboxylate.

Any suitable aminopolycarboxylate can be used when the redox active species is an organometallic chelate comprising Cr chelated to an aminopolycarboxylate. Exemplary, though non-limiting, aminopolycarboxylates suitable for use include EDTA and PDTA. Several isomer forms of PDTA exist. When used as the ligand for the chelated chromium compound, it should be appreciated that reference herein to PDTA means 1,3-PDTA, 1,2-PDTA, or mixtures thereof.

In some embodiments, the organometallic chelate used for the redox active species comprises a counter ion. While any suitable counter ion can be used, in some embodiments, the counter ion is preferably selected from the group consisting of potassium, sodium, lithium, ammonium, tetraethylammonium, tetrabutylammonium, or a tetraalkylammonium salt.

### EXAMPLE 1

In a first example, the electrolyte solution comprises 0.5 M CrEDTA as the redox active species and 0.5 M sodium phosphate as the buffer. In this example, the electrolyte solution has a pH in the range of from 5 to 11.

### EXAMPLE 2

In a second example, the electrolyte solution comprises 0.5 M CrPDTA as the redox active species and 0.5 M PDTA as the buffer. In this example, the electrolyte solution has a pH in the range of from 5 to 11.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/we claim:

1. An electrolyte solution comprising:
a redox active species at a concentration greater than 0.4 M; and
a buffer at a concentration greater than 0.4 M;
wherein the pH of the electrolyte solution is in the range of from 5 to 11.

2. The electrolyte solution of claim 1, wherein the concentration of the buffer is equal to or greater than the concentration of the redox active species.

3. The electrolyte solution of claim 1, wherein the redox active species is an organometallic chelate.

4. The electrolyte solution of claim 3, wherein the organometallic chelate has a metal center of Cr or Fe.

5. The electrolyte solution of claim 3, wherein the organometallic chelate comprises Cr or Fe chelated to an aminopolycarboxylate.

6. The electrolyte solution of claim 5, wherein the aminopolycarboxylate is EDTA or PDTA.

7. The electrolyte solution of claim 3, wherein the organometallic chelate comprises a counter ion selected from the group consisting of potassium, sodium, lithium, ammonium, tetraethylammonium, tetrabutylammonium, or a tetraalkylammonium salt.

8. The electrolyte solution of claim 1, wherein the buffer is any buffer capable of buffering in at a pH between 5 and 11.

9. The electrolyte solution of claim 1, wherein the buffer is selected from the group consisting of phosphate, acetate, phthalate, borate, citrate, carbonate, ammonium, 2-amino-2-methyl-1,2-propanediol, tris(hydroxymethyl)aminomethane, EDTA, or PDTA.

10. The electrolyte solution of claim 1, wherein the redox active species is CrEDTA and the buffer is phosphate.

11. The electrolyte solution of claim 10, wherein the concentration of CrEDTA is 0.5 M and the concentration of phosphate is 0.5 M.

12. The electrolyte solution of claim 1, wherein the redox active species is CrPDTA and the buffer is PDTA.

13. The electrolyte solution of claim 12, wherein the concentration of CrPDTA is 0.5 M and the concentration of PDTA is 0.5 M.
